(19) United States
(12) Patent Application Publication
(10) Pub. No.: US 2015/0178695 A1
(43) Pub. Date: Jun. 25, 2015

(54) POINT TO MULTI-POINT ENERGY TRANSACTION PLATFORM AND RELATED METHODS OF USE

(71) Applicant: Georgios KOUTITAS, Thessaloniki (GR)

(72) Inventor: Georgios KOUTITAS, Thessaloniki (GR)

(21) Appl. No.: 14/137,509

(22) Filed: Dec. 20, 2013

(51) Int. Cl. G06Q 20/08; G06Q 50/06; G06Q 20/14

(52) U.S. Cl. CPC G06Q 20/085; G06Q 20/145; G06Q 50/06

(57) ABSTRACT

A method for processing on a computer point to multi-point energy transactions between users of energy networks includes receiving an energy packet from a sender at a sender point, identifying at least one recipient and at least one destination point for said energy packet according to characteristics provided therewith and in reference to a user database, and translating said energy packet into a second equivalent energy packet according to characteristics of said sender and recipient and in reference to a translation database. The method further includes applying rules to said second equivalent energy packet according to characteristics of said sender and recipient and in reference to a rules database, storing information relating to said energy transactions in a separate database, and transmitting said second equivalent energy packet to said recipient, and updating accounts of said sender and recipient according to said energy transactions.

### BACKGROUND

1. Field

Embodiments disclosed herein relate generally to the field of energy and electronic communications, and more specifically, to distributing energy packets as a form of energy and/or cost transaction schemes independently of the sender and destination users' characteristics.

2. Background

In recent years, electronic communication systems have provided enhanced degrees of freedom to users to exchange information packets such as text and multimedia. Web-based platforms may support device independent messaging and real time communications independent of the operator and service provider of the users and the location of the users. However, these types of systems and methods are generally not yet available in the energy sector. With the synergy of information and communication technology (“ICT”) sector and the energy network, new concepts and services have emerged in the general domain of smart grids. A smart grid may be any intelligent grid network (e.g., electrical distribution, gas, water) that supports real time management of the network.

Current energy networks are characterized by limitations regarding user-to-user interaction. Usually, there is a “strict” relationship in the form of a contract between an energy service provider (“ESP”) and an end user, where the end user is restricted to exchanging resources, such as energy and information, solely with a specific ESP. In some instances, end user and ESP relationships have become more flexible with bilateral agreements and differential contracts that have emerged to cover exceptional cases. Recently, smart meters coupled to web-based platforms have provided two-way interactive communication between the ESP and the user. While there is some ability for active participation of end users to the energy market, there are still limitations. For example, new concepts have emerged to enable an end user to choose, in real time, the ESP that minimizes energy costs over a limited time horizon. In addition, it is possible to model an electric vehicle as an entity that may manage its own charging by means of an energy transaction broker or by means of charging bill roaming. Finally, energy roaming between end users may be supported by means of devices that may support roaming in the telecommunication network.

Currently available systems and methods are generally provider-specific (e.g., a user must use a specific infrastructure, such as an electric vehicle and a charging point), and often require the use of additional devices needed to intervene for the realization of the final target. Available systems also are limited by the amount of information that end users need to have access to for the transaction scheme to be realized, and in the case of point-to-point energy transactions, between utilities and/or providers. Additionally, there is no general method for sending an energy packet from a single end user to multiple end users utilizing different energy distribution networks. For example, an end user of the electricity network may want to send an energy packet to two end users, one in the electricity network and one in a separate gas network.

In general, currently available systems in the energy networks lack a system and a method for sending an energy packet from an end user to multiple destination end users, where the sender and the destinations users are using different energy networks and/or different energy service providers, and where the sender user does not need to have knowledge of the destination's characteristics. In other words, there is a need for a system and method to allow a user-to-user interaction in the energy networks in terms of an energy transaction scheme coupled with an interactive communication platform.

### SUMMARY

In one or more aspects, embodiments disclosed herein relate to a system and method for point to multi-point energy transactions between users of energy networks. The transaction is performed by transmitting energy packets. The size and type of the energy packet is user specific, for example the user of an electricity network may choose to transfer a monetary amount to a user of a gas network or an amount of energy to a user of an electricity network. In certain cases, the energy packet may be used for energy issues or as a monetary transaction to the energy bill of the sender and destination users. The system includes a roaming engine that is responsible for performing energy roaming, that is to translate the energy packet according to the information and identities (e.g., characteristics) of the users and to apply rules to the energy packet based on the sender and destination user information. The system also includes a virtual meter engine that is responsible for performing billing, that is to modify the accounts of the sender and destination users according to the transacted energy packets. The system assigns an equivalent to the original (send) energy packet to the destination users according to the rules imposed. In this system, the users do not require having knowledge of the destination's characteristics and they do not need to be part of the same energy network or energy service provider (ESP).

In certain instances, for the transaction to be performed, the users may be “connected,” for example a destination user may accept a collaboration request from a sender user, or vice versa. Upon acceptance of the collaboration request they may be regarded as energy ‘mates’. The collaboration scheme is supported by the system. Methods disclosed herein may be supported by a web-based platform. The system beneficially allows dynamic user interaction in energy networks by means of electronic communication platforms, such as the web.

### BRIEF DESCRIPTION OF THE DRAWINGS

The invention is illustrated in the accompanying drawings wherein,

FIG. 1 illustrates one embodiment of the point to multi-point energy transaction system.

FIG. 2 illustrates one embodiment of the roaming engine, for example as shown in FIG. 1.

FIG. 3 illustrates one embodiment of the virtual meter engine, for example as shown in FIG. 1.

### DETAILED DESCRIPTION

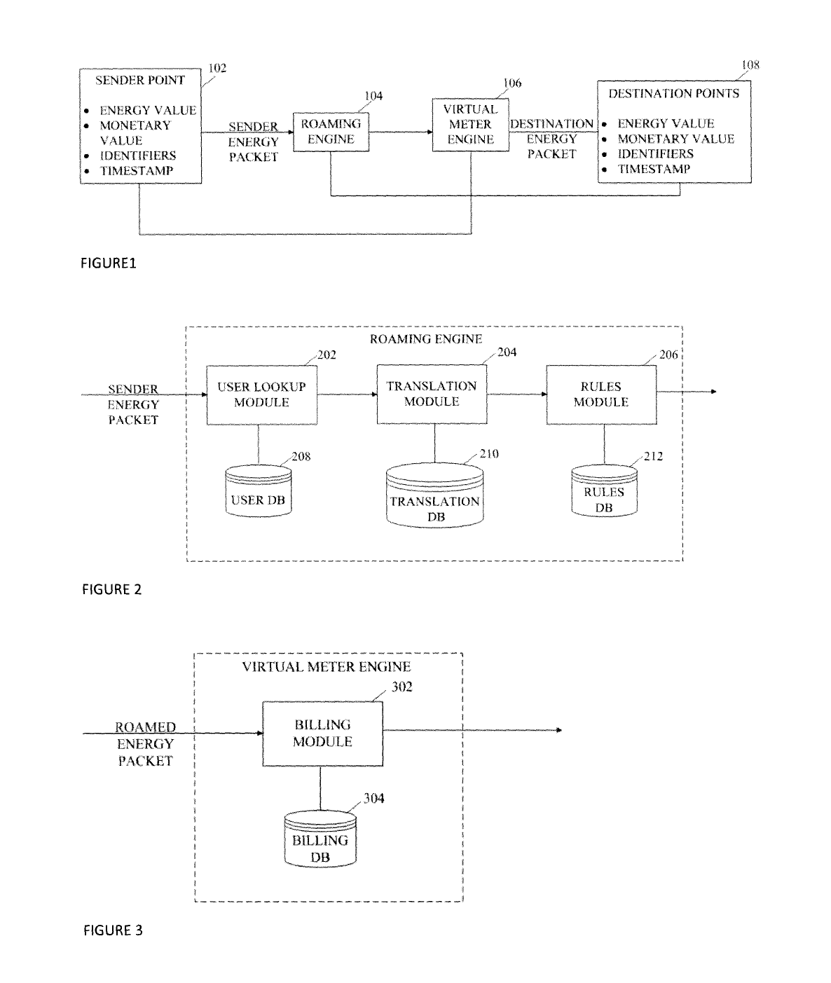

Reference will now be made in detail to several embodiments, examples of which are illustrated in the accompanying Figures. The Figures depict embodiments of the disclosed system (and/or method) for purposes of illustration only. One skilled in the art will readily recognize from the following description that alternative embodiments of the structures and methods illustrated herein may be employed without departing from the principles described herein. Referring now to one or more embodiments in more detail, shown in FIGS. 1, 2 and 3, there is shown an overall description of the system for a point to multi-point energy transaction, the roaming engine and the virtual meter engine of the system.

FIG. 1 illustrates a schematic of the point to multi-point energy transaction system 100 in accordance with one or more embodiments. The system 100 includes a sender point 102, a roaming engine 104, a virtual meter engine 106 and the destination point 108. The sender point 102 is communicatively coupled with the roaming engine 104; the roaming engine 104 is communicatively coupled with the virtual meter engine 106; the virtual meter engine 106 is communicatively coupled with the destination point 108; the sender point 102 is communicatively coupled with the virtual meter engine 106; and the destination point 108 is communicatively coupled with the roaming engine 104.

A sender or a first user, or an end user, composes an energy packet to be sent from the sender point 102 to a recipient or a second user at the destination point 108. The energy packet may be a specific amount of energy (possibly in kWhr or Whr) or a monetary value in local currency. This value indicates the size of the energy packet but for simplicity is referred as the energy packet. The energy packet also includes identifiers for the sender and destination addresses. The energy packet may also include a timestamp to indicate the preferred time period of energy packet allocation at the destination point, that is, to indicate a preferred time for transmitting the energy packet to the recipient and the destination point. In case the energy packet is defined as a monetary value, the energy packet may be translated to an amount of energy based on the energy price of the network and/or ESP of the sender user. The energy price is usually given as a monetary value per kWhr and it can be constant or time variant. There are several possible platforms, devices and interfaces for creating and sending the energy packet such as a desktop or laptop PC, a mobile device or a tablet connected to the interne. For example, the interface may be a web-based platform.

The roaming engine 104 receives an energy packet from the sender point 102 and determines where the energy packet is to be sent and how it should be translated according to the information of the sender point 102 and destination points 108. The roaming engine attaches translation information and rules information to the energy packet received from the sender point and creates a “roamed” energy packet. The roamed energy packet includes all the necessary information to create an equivalent energy packet that may be transmitted to the destination point and also to create an equivalent energy packet to compute the transaction costs for the sender point that are related to the transaction of the sent energy packet. The definition of the translation information and the rules information may be performed by means of further communication with external databases that may associated with the energy service providers (ESP) and/or the smart meter service providers of the sender point 102 and the destination point 108. The roaming engine 104 sends the processed (roamed) energy packet to the virtual meter engine 106. The roaming engine 104 is described further below.

The virtual meter engine 106 receives the roamed energy packet from the roaming engine 104. The virtual meter engine 106 processes the translation information, the rules information and the size of the energy packet and creates equivalent energy packets that are used to modify the accounts of the sender and destination users. The virtual meter engine 106 is responsible to store the information of the transactions between the sender point 102 and destination point 108. The virtual meter engine 106 may also communicate with the accounts of the sender and destination points associated to their energy service providers (ESP) and/or the smart meter service providers and update transaction information. This process may be considered as a virtual billing process. This is performed by means of further communication with external databases that are associated to the energy service providers (ESP) and/or the smart meter service providers of the sender point 102 and the destination point 108. The virtual meter engine 106 is described further below.

The destination point 108 receives the final roamed (equivalent) energy packet from the virtual meter engine 106. The destination point is assigned the energy packet to his/her account and may use it within a specific time period. The time period may be user specific or in case of cooperation with the ESP to be agreed in a contract.

FIG. 2 illustrates a schematic of the roaming engine 104 in the system of FIG. 1. The roaming engine 104 includes a user lookup module 202, a user database (“DB”) 208, a translation module 204, a translation DB 210, a rules module 206 and a rules DB 212. The user lookup module 202 is communicatively coupled with the user DB 208 and the translation module 204. The translation module 204 is communicatively coupled with the rules module 206 and the translation DB 210. The rules module 206 is communicatively coupled with the rules DB 212.

An energy packet (from the sender point 102) is received by the user lookup module 202. The user lookup module processes the energy packet identifiers (addresses) to identify the recipient users (destination points) and to obtain user membership data from the user DB 208. In case of the existence of more than one identifiers (group of recipients), the lookup module obtains group membership and group identification from the user DB 208. For example, an energy packet may be addressed to a single destination user or a group of destination users. For example, a group may be named as ‘Relatives’ which includes multiple addresses (identifiers) from the sender user's relative environment (brother, sister, grandfather, etc. . . . ). Users may define individuals or groups and send these definitions in the roaming engine 104 that stores them in the user DB 208. For this procedure to be realized, the sender user and the destination users need to have agreed to collaborate in the energy packet transaction process (in other words to be ‘connected’), probably by means of a web based platform that support ‘add’ messages. For example a destination user needs to accept the collaboration request message ‘add’ from the sender user, or vice versa. Upon acceptance of the collaboration they are regarded as energy ‘mates’. The membership group may be controlled by a single user or by multiple users that are incorporated in the group. Individual users may remove themselves from a group be sending a ‘remove’ message to the roaming engine 104.

The user lookup module 202 does not specify the method of energy packet transaction. For example, an energy packet of size X in kWhrs from UserX of the electricity network of ESP XX may be addressed to a destination user UserY of the electricity network of ESP YY without specifying if UserY belongs in the ESP YY. The method to translate the energy packet of size X to an equivalent energy packet of size Y is performed by the roaming engine 104. Thus, UserX does not need to have detailed knowledge on the characteristics of UserY.

The user lookup module 202 looks up the registered information for each sender and destination users to enable the energy packet to be delivered to the final destinations. The roaming engine 104 uses this information to translate the original energy packet. This information is incorporated in the user DB 208. The information includes user's address and location and characteristics such as type of energy network used, energy service provider and/or smart meter service provider characteristics such as name and/or registration number. The information stored in the user DB 208 might also include user's web interface login and password as well as contact details (emails, phone number, social network identifier). The characteristics of the users may change over time by updates of the users on the user DB 208. This may be performed by a web portal using login details (username and password).

The user lookup module 202 retrieves all the required information from the user DB 208 and attaches them to the energy packet as additional information together with the energy value for the transaction, the identifiers and the timestamp that were already incorporated within the energy packet sent by the sender point 102. The energy packet is received by the translation module 204. The translation module 204 processes all the information of the energy packet and attaches translation information upon the energy packet. The translation information may be used to translate the energy value incorporated within the energy packet according to the characteristics of the sender and destination users. For example, UserX of the electricity network of ESP XX wants to transfer an energy packet of size X in kWhr to a destination user UserY of the electricity network of ESP YY. The translation module 204 is responsible to determine translation information that can be used to find an equivalent to the original energy packet of size X in kWhr, amount of transaction that will be assigned to UserY and that will result to an energy packet of size Y in kWhr. This translation is performed by considering the information retrieved by the user lookup module 202 and the information of the translation DB 210. The information stored in the translation DB 210 may be real time and/or forecasted energy prices from the ESP of UserX and UserY or conversion formulas between different energy networks. For example if UserX belongs to the electricity network and UserY belongs to the gas network then the translation DB 210 will obtain energy conversion data that will be processed by the translation module 204 for the translation of energy packet of size X to the energy packet of size Y to be realized. For this example, if UserX wants to transfer an energy packet of 10 kWhrs to UserY and the energy price of ESP XX is 0.1$/kWhr whereas the energy price of ESP YY is 0.05$/kWhr then the conversion should translate the 10 kWhrs energy packet of UserX to a 20 kWhrs energy packet at UserY. Another example may be for the case where the ESP YY uses a different metric to model energy. If for example ESP YY uses Nm3 metric to model natural gas energy and at the time instance of the energy packet transaction, the analogy is 1 Nm3=10 kWhr then the conversion should translate the 10 kWhrs energy packet of UserX to a 1 Nm3 energy packet of UserY. Of course, if UserX and UserY belong in the same type of energy network (for example electricity) and are served by the same ESP then the energy packet of UserX of size X will be translated to an energy packet also of size X and will be assigned to UserY.

The rules module 206 receives the translated energy packet from the translation module 204. The rules module 206 applies rules (attaches rules information) to the energy packet to further determine if the transaction of the energy packets is feasible as it is or if rules should be applied. Rules may include for example thresholds of energy packet transactions over a specific time period, feasibility of energy packet transaction according to energy consumption and/or production and/or storage of sender and destination users, additional charging/transaction fees (they may be referred as commission fees) that might occur by third parties (such as the ESPs, the smart meter service provider, etc.) of the sender and destination users, preference of who will be charged for the commission fees (for example the sender user, the destination user or both of them). For example, a sender user may specify that only a specific amount of energy per month may be transferred to a specific destination user. In that case, the rules module 206 will process the information of the energy packet, check historical transactions between the sender user and the destination user and might modify the energy packet. Another example may be the case where the ESP of the sender user might want to add additional charges (impose commission fees) for the transaction. In that case, the rules module 206 will attach the additional charges information on the energy packet. The rules module 206 communicates with the rules database 212 that include all the information regarding the rules. The rules DB 212 may also include information about the energy prices and preferences set by third parties. The characteristics of the rules DB 212 may change over time by updates of the users during or after registration to the platform or the third parties (ESPs, smart meter service providers, etc.) on the rules DB 212. This may be performed by a web portal using login details (username and password) or by external communication of the rules DB 212 with the third parties' databases.

FIG. 3 illustrates a schematic of the virtual meter engine 106 in the system of FIG. 1. The virtual meter engine 106 includes the billing module 302 and the billing DB 304. The billing module 302 is communicatively coupled with the billing DB 304. A roamed energy packet (from the roaming engine 104) is received by the billing module 302. The billing module processes the roamed energy packet and the information incorporated within the roamed energy packet and is responsible to compute equivalent energy packets that will be assigned to the accounts of the sender and destination users. The billing module 302 also stores the information and the transaction activity. The final transaction activity between the sender and the destination user is performed by modifying their accounts according to the attached translation information and rule information of the roamed energy packet. For the destination user, the billing module 302 computes an equivalent energy packet according to the translation information, the rules information and the size of the original energy packet. This equivalent energy packet is stored in the account of the destination user. For the sender user, the billing module 302 processes the rules information of the energy packet and the size of the original packet and computes an equivalent energy packet. This equivalent energy packet is stored in the sender user account. All this activity is stored at the billing DB 304. The transaction activity is modeled as an energy value derived from the equivalent energy packets and/or as a monetary value derived by the size of the equivalent energy packets and the energy prices of the ESPs of the sender and destination users accompanied with the time indication of the transaction. The billing module 302 determines the addresses of the transaction (the sender point and the destination points) as well as the amount of the transaction. The billing module 302 stores all the transaction activity within the billing DB 304 to provide the required references to the users (sender and destination users) as well as to third parties which this transaction concerns. For example, the third parties may be the ESPs of the sender and destination users or even the smart meter service provider that might be responsible for smart meters deployed at the sender and destination users. The billing DB 304 also includes information about energy prices and demand response events by the third parties (ESPs or smart meter service providers) so as to notify sender and destination users interfaces using the communication platform of the system (and/or method). The billing module aggregates the transactions of the users and may operate as virtual meter machine that captures all the energy transaction during a specific time period. The time period may be defined by the users or the third parties. The transaction may be performed by means of additions and subtractions to the aggregated recordings of the virtual meters. For example, if UserX of ESP XX sends an energy packet of size X to UserY of ESP YY and the final roamed energy packet (equivalent energy packet) computed by the virtual meter engine for UserX is of size Z whereas the final roamed energy packet (equivalent energy packet) computed by the virtual meter engine is of size Y then the account of UserX will be added (charged) with the energy value Z while the account of UserY will be subtracted (credited) by the energy value Y. The information stored in the billing DB 304 may be used by different interfaces, such as web based portals, to provide real time and historical analytics to the users and third parties involved in the energy packet transactions. The virtual meter engine may also communicate with the ESPs of the sender and destination users in order to inform about the necessary monetary transactions required to be performed between the ESPs for the realization of the final energy packet transaction. For the case of the previous example, ESP XX should send a monetary value to ESP YY to cover the energy consumption expenses. The monetary value may be computed according to the size of the original energy packet (send energy packet from UserX) and the energy price at the time instance of the energy packet allocation or based on average energy prices.

In one embodiment, energy packets are dropped if they may not be delivered. The final decision on the energy packet is taken from the rule module 206. For example, if a sender user sends an energy packet to the destination user who has exceeded a maximum predefined threshold that is incorporated in the rules DB 212, then the transaction of this energy packet is rejected. In that case a notification may be sent to the destination user, possibly using the web platform interface.

A user registers with the system so that the user is able to send or receive energy packets. The registration process may be completed by using for example a web platform. A user may send a registration message to the system specifying a username and a password. Once an account is created for the user, the user is required to provide data that are necessary for the system. For example, the data may be the name of ESP, registration number to ESP, location, typical energy consumption and/or production and/or storage values, smart meter id and/or vendor, contact details, thresholds/limitations for the rules, preference of who will cover potential commission fees (sender or destination user) imposed by the ESPs or in general the third parties that might be involved in the transaction process, etc.

The system stores the user information in the relevant databases and registers the user. The system sends back an acknowledgement to confirm registration. For an energy packet to be transferred between a sender and a destination user, the sender user and the destination user need to have agreed to collaborate in the energy packet transaction process (in other words to be ‘connected’), by means of a web based platform that support ‘add’ messages. For example a destination user needs to accept the collaboration request message ‘add’ from the sender user, or vice versa. Once the collaboration is accepted, then the sender and destination users are regarded as energy ‘mates’.

Advertisements may be shown to users in sync with the energy packets and may be targeted to the information of the users, for example, the location, the amount of energy transaction, the destination user, the ESP, the time and date. Notifications and demand response events may be sent to the sender and destination users interfaces by the energy service provider (and/or the smart meter service provider) utilizing electronic communications of the proposed method (and/or system). In case the timestamp is neglected in the definition of the energy packet of the system (and/or method), then the translation of the energy packet is based on average energy prices for the specific billing period.

It should be understood that the energy packet defined in the aforementioned procedure may include an amount of energy or a monetary value for the transaction. This means that the procedure remains the same in the event that the sender user sends a monetary value instead of an amount of energy. The translation module 210, the translation DB 210, the rules module 206 and the rules DB 212 may process this information and obtain the same information required by the virtual meter engine 106.

It should also be understood that the aforementioned procedure remains the same in the event that the sender user sends an energy packet to multiple destination users. For that case, the aforementioned procedure may be executed in a loop process for the same size of the original send energy packet but for the multiple destinations. It should also be noted that before the energy packet transaction to be realized, the system may inform the sender user about the approximate size of the final energy packet transaction taking into account the translation information and the rules information of the roaming engine 104. It should also be noted that for the case that the ESPs of the sender and destination users are placed in different countries with different currencies (for example Euros and US dollars) then the rules module 206 and the rules DB 212 attaches the required currency information that are processed by the virtual meter engine 106 to specify the final equivalent energy packets and the exact transaction. Finally, it should be noted that once two points (sender and destination users) have agreed to collaborate (they became energy mates) then the destination user can also send an energy packet to the sender user. In other words, a sender user can also become a destination user.

The following is an example of the system and methods described herein in accordance with one or more embodiment. There are two users: User1 and User2. User1 belongs to ESP1 and User2 belongs to ESP2. The users are energy ‘mates’ (e.g., they agreed to make energy packet transactions using a web-based platform). They are both utilizing electricity network and they both agreed to cover the commission fees that might be imposed by their respective ESPs. User1 is about to make a visit to User2 for one day and User1 wants to transfer 10 kWhr of energy to User2. This amount of energy was calculated by User1 that will be required to cover his or her energy footprint during the visit. User1 knows that approximately 4 kWhr of energy will be used between 9:00 am-11:00 am on Nov. 24, 2014 to charge his or her electric vehicle, and 6 kWhr of energy will be used between 5:00 pm-8:00 pm on Nov. 24, 2014 to cook, have a hot shower, etc. ESP1 has set a commission fee for any energy packet transaction equal to $0.05 US and ESP2 a commission fee equal to $0.01 US. During the time period 9:00 am-11:00 am on Nov. 24, 2014, the energy price that is set by ESP1 is 0.1 US$/kWhr and the energy price that is set by ESP2 is 0.11 US$/kWhr and during the period 5:00 pm-8:00 pm on Nov. 24, 2014 the energy price that is set by ESP1 is 0.09 US$/kWhr and the energy price that is set by ESP2 is 0.08 US$/kWhr.

User1 logs in to the web portal using a username and password. User1 sends two energy packets to User2: Packet1, of size 4 kWhr, with a time stamp to be used on 9:00 am-11:00 am on Nov. 24, 2014, and Packet2, of size 6 kWhr, with a time stamp to be used on 5:00 pm-8:00 pm on Nov. 24, 2014. Within the energy packets the amount of energy, the identifiers of the sender and destination users and the timestamps are incorporated. The energy packets (Packet1 and Packet2) are received by the roaming engine 104. The user lookup module 202 establishes the connection for the energy transaction. The energy packets are then transferred to the translation module 204. Based on the energy prices between ESP1 and ESP2 and the amount of energy incorporated within the energy packets (size of energy packets), the translation module attaches translation information about the translation of the energy packets. The translation is based on information about real time or forecasted energy values and/or conversion formulas that are incorporated in the translation DB 210. For this example, the translation information for Packet1 may include the value −0.3636 kWhr (4 kWhr*0.1$/kWhr/0.11$/kWhr−4 kWhr) and the translation information for Packet2 may include the value +0.75 kWhrs (6 kWhr*0.09$/kWhr/0.08$/kWhr−6 kWhr). The negative sign means that the translated energy packet is reduced in size compared to the original size of the energy packet, based on the difference on energy prices of the ESPs, and vice versa.

The translated energy packets are then processed by the rule module 206. The transaction incurs a specific charge amount as determined or set by ESP1 and ESP2. For this example, ESP1 has set a commission fee for any energy packet transaction equal to $0.05 US and ESP2 a commission fee equal to $0.01 US. The monetary value may be converted to an equivalent amount of energy based on data stored in the rule DB 212. The conversion may be based on the energy prices during the energy packet allocation or on average energy prices during the billing period of the users. This information is incorporated in the rules DB 212 and may be set by the third parties (for example the ESPs) by means of further communication of the rules DB with the databases of the third parties. The rules module attaches rules information of the translated energy packet that is necessary to compute the effect of the commission fees. For Packet1 and User1 the rule information is equivalent to the value 0.5 kWhr (0.05$/0.1$/kWhr), for Packet2 and User1 the rule information is equivalent to the value 0.5556 kWhr (0.05$/0.09$/kWhr), for Packet1 and User2 the rule information is equivalent to the value −0.0909 kWhr (−0.01$/0.11$/kWhr) and for Packet2 and User1 the rule information is equivalent to the value −0.125 kWhr (−0.01$/0.08$/kWhr). The minus sign indicates that the values need to be subtracted from the energy packet and vice versa to consider the effect of the commission fees upon the accounts of User1 and User2. The sign may change according to the information stored in the rules DB 212 describing the preferences of who (sender or destination users) cover the commission fees. This information is stored during registration or it may be updated using the platform.

After said rules are imposed, the roamed energy packets are received by the virtual meter engine 106. The billing module 302 of the virtual meter engine 106 computes the final energy packets for User1 and User2 that will be used for the modification of their accounts. The billing module processes all the information in the roamed energy packets to compute the equivalent energy packets that are directly related to the final transaction. For User1 the billing module computes the equivalent Packet1 of size 4.5 kWhr (4 kWhr+0.5 kWhr) and Packet2 of size 6.5556 kWhr (6 kWhr+0.5556 kWhr). For User2 the billing module computes the equivalent Packet1 of size 3.5455 kWhr (4 kWhr−0.3636 kWhr−0.0909 kWhr) and Packet2 of size 6.6255 kWhr (6 kWhr+0.75 kWhr−0.125 kWhr). The billing module 302 stores at the billing DB 304 the transaction of the equivalent Packet1 of User1 (4.5 kWhr) and equivalent Packet2 of User1 (6.5556 kWhr) as additional consumed energy to the account of User1 (they are added to the electricity meter or bill of User1) and the equivalent Packet1 of User2 (3.5455 kWhr) and equivalent Packet2 of User2 (6.6255 kWhr) as ‘charged’ (or else credited) energy to the account of User2 (subtracted from the electricity meter or bill of User2). The billing module may also inform ESP1 that needs to pay ESP2 the amount of $0.94 US (4 kWhr*0.1$/kWhr+6 kWhr*0.09$/kWhr) to fulfill energy transaction costs. User1 visits User2 and may consume energy without having the feeling that he or she increases the living expenses of User2.

Advantageously, embodiments disclosed herein provide without limitation a point to multi-point energy transaction platform. The system (and method) allows for energy packet transaction between users of the energy network, providing for the first time interaction between users of multiple different energy networks. In this system, the sender user does not need to have detailed knowledge about the characteristics of the destination user. The energy packet may be translated to capture the heterogeneous nature between different ESPs of the same type of energy network, for example the electricity network, or between different types of energy networks, for example the electricity and the gas network. Additionally, advertisements may be provided to users based on user activity and characteristics in the system. In a broad sense, embodiments disclosed herein provide the first platform that enables interaction between users in the energy networks and provides the ability to individual users to act as real energy providers of small scale.

As used herein any reference to ‘one embodiment’ or ‘an embodiment’ means that a particular element, feature, structure, or characteristic described in connection the embodiment is included in at least one embodiment. The appearances of the phrase ‘in one embodiment’ in various places in the specification are not necessarily all referring to the same embodiment. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method for processing on a computer point to multi-point energy transactions between users of energy networks, the method comprising:
receiving an energy packet from a sender at a sender point;
identifying at least one recipient or at least one destination point for said energy packet according to characteristics provided therewith and in reference to a user database;
translating said energy packet into a second equivalent energy packet according to characteristics of said sender and recipient and in reference to a translation database;
applying rules to said second equivalent energy packet according to characteristics of said sender and recipient and in reference to a rules database;
storing information relating to said energy transactions in a separate database; and
transmitting said second equivalent energy packet to said recipient, and updating accounts of said sender and recipient according to said energy transactions.

2. The method of claim 1, further comprising facilitating an agreement between said sender and recipient to collaborate in said energy transaction.

3. The method of claim 2, further comprising facilitating said agreement by receiving a request from said sender to collaborate with said recipient and forwarding said request to said recipient, and receiving an acceptance from said recipient in response to said request.

4. The method of claim 1, further comprising indicating a preferred time period for transmitting said energy packet to said recipient at the destination point.

5. The method of claim 1, further comprising receiving said energy packet composed by said sender absent specified characteristics relating to said recipient.

6. The method of claim 1, further comprising notifying said sender or recipient regarding events relating to said energy transaction.

7. The method of claim 1, further comprising applying conversion formulas for translating said energy packet.

8. A system executed by a computer processor for transmitting energy packets between at least one sender point and at least one destination point, the system comprising:
a roaming engine configured to receive said energy packet from said sender point and determine where said energy packet is to be sent according to information of said sender and destination points, and then create a roamed energy packet, said roaming engine comprising:
a user lookup module and associated user database, wherein said user lookup module is configured to process energy packets upon receipt and identify recipient users and obtain user membership data from said user database;
a translation module and associated translation database, wherein said translation module is configured to attach translation information retrieved from said translation database to said energy packet;
a rules module and associated rules database, wherein said rules module is configured to attach rules information retrieved from said rules database to said energy packet; and
a virtual meter engine configured to receive said roamed energy packet from said roaming engine and create equivalent energy packets to be assigned to said sender and destination points, said virtual meter engine comprising a billing module and associated billing database, wherein said billing module is configured to modify said sender and destination points according to said translation and rules information, and store transaction activity at the billing database.

9. The system of claim 8, wherein said energy packet comprises identifiers of said sender and destination users, a size for indicating the amount of the transaction and a timestamp incorporated therewith for indicating a preferred time period for transmitting said energy packet among said users.

10. The system of claim 8, wherein said user lookup module is configured to receive said energy packet absent specified characteristics relating to said recipient user.

11. The system of claim 8, wherein said translation module translates the size of said energy packet according to conversion formulas that depend on the type of energy network and the energy service providers of users.

12. The system of claim 8, wherein said rules module is configured to determine whether said energy transaction requires specified rules to be applied thereto before said energy packet is transmitted to recipient users.

13. The system of claim 12, wherein said rules module is configured to check historical transactions between users, to check energy consumption and/or production and/or storage information, to apply possible additional charges/transaction fees (or else commission fees), and to check where the commission fees should be imposed between the sender and recipient users according to their preference registered at the database.

14. The system of claim 8, wherein said roaming engine and virtual meter engine are configured to communicate with one or more third party databases.

15. The system of claim 8, wherein said user lookup module, translation module and rules module are configured to store information relating to agreements among said users to collaborate in said energy transactions.

16. The system of claim 8, wherein said billing module is configured to send notifications regarding events relating to said energy transaction to said users.

17. A non-transitory computer readable medium comprising a computer program, which when executed by a processor, performs a method of processing point to multi-point energy transactions, the method comprising:
receiving an energy packet composed by a first user to be sent to a second user;
identifying said second user according to characteristics provided with said energy packet and in reference to a user database;
translating said energy packet into a second equivalent energy packet according to characteristics of said first and second users and in reference to a translation database;
applying rules to said second equivalent energy packet according to characteristics of said first and second users and in reference to a rules database;
storing information relating to said energy transactions in a separate database; and
transmitting said second equivalent energy packet to said second user, and updating accounts of said first and second users according to said energy transactions.

18. The method of claim 17, further comprising facilitating an agreement between said first and second users by receiving a request from said first user to collaborate with said second user and forwarding said request to said second user, and receiving an acceptance from said second user in response to said request.

19. The method of claim 17, further comprising providing indicating a preferred time period for transmitting said energy packet to said second user.

20. The method of claim 17, further comprising notifying said first or second user regarding events relating to said energy transaction.
